(19) United States
(12) Patent Application Publication
(10) Pub. No.: US 2026/0084949 A1
(43) Pub. Date: Mar. 26, 2026

(54) LIFT SYSTEMS AND SUPPORTING COLLARS FOR LIFT SYSTEMS

(71) Applicant: Enerpac Tool Group Corp., Milwaukee, WI (US)

(72) Inventor: Nicholas Joseph Zeidler, Brookfield, WI (US)

(73) Assignee: Enerpac Tool Group Corp., Milwaukee, WI (US)

(21) Appl. No.: 19/223,144

(22) Filed: May 30, 2025

Related U.S. Application Data
(60) Provisional application No. 63/697,888, filed on Sep. 23, 2024.

(51) Int. Cl. B66F 17/00

(52) U.S. Cl. CPC B66F 17/00; B66F 2700/052

(57) ABSTRACT

A supporting collar is for a lift system having a piston rod that is extendable out of a cylinder to raise a load. The supporting collar has a first body portion including a first sidewall segment; a second body portion pivotably coupled to the first body portion by a pivot hinge, the second body portion having a second sidewall segment. The first and second body portions are pivotable relative to each other into an open position in which the piston rod is receivable between the first and second sidewall segments and a closed position in which the piston rod is retained between the first and second sidewall segments. The first and second sidewall segments are configured to support a weight of the load; and a grip actuator configured for a user to pivot the first body portion and the second body portion into the open position

### CROSS-REFERENCE TO RELATED APPLICATION

This application claims priority to U.S. Provisional Ser. No. 63/697,888 , filed on Sep. 23, 2024, which application is incorporated herein in entirety.

### FIELD

The present disclosure relates to systems and apparatuses for lifting loads.

### BACKGROUND

U.S. Pat. No. 5,681,029 discloses a modular jack device having a set of load holding rings configured to be placed around a piston between the saddle and the top end of the hydraulic cylinder. The rings are intended to support a load and to maintain the piston in an extended position. Each load holding ring is generally U-shaped and configured to radially slide onto the piston rod axially between the load supporting saddle and the hydraulic cylinder.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

A supporting collar is for a lift system having a piston rod that is extendable out of a cylinder to raise a load. The supporting collar comprises a first body portion including a first sidewall segment; a second body portion pivotably coupled to the first body portion by a pivot hinge, the second body portion comprising a second sidewall segment; wherein the first body portion and the second body portion are pivotable relative to each other into an open position in which the piston rod is receivable between the first sidewall segment and the second sidewall segment and a closed position in which the piston rod is retained between the first sidewall segment and the second sidewall segment; wherein the first sidewall segment and the second sidewall segment are configured to support a weight of the load; and a grip actuator configured for a user to pivot the first body portion and the second body portion into the open position.

In embodiments, the grip actuator includes a first grip lever on the first body portion and a second grip lever on the second body portion, and wherein pinching the first grip lever and the second grip lever together pivots the first sidewall segment and the second sidewall segment apart from each other.

In embodiments, the pivot hinge includes a spring that biases the first body portion and the second body portion into the closed position. Optionally the first sidewall segment and the second sidewall segment are configured to be clamped onto the piston rod by the spring.

In embodiments, the supporting collar further comprises a ramped entryway at an opening between the first body portion and the second body portion, the ramped entryway being configured to bias the first sidewall segment and the second sidewall segment apart from each other into the open position as the ramped entryway is radially slid onto the piston rod. Optionally the pivot hinge includes a spring that biases the first body portion and the second body portion into the closed position. Optionally the first sidewall segment and the second sidewall segment are configured to be clamped onto the piston rod by the spring. Optionally the supporting collar further comprises a ramped entryway at an opening between the first body portion and the second body portion, the ramped entryway being configured to bias the first sidewall segment and the second sidewall segment apart from each other into the open position as the ramped entryway is radially slid onto the piston rod.

A lift system for lifting a load. The lift system comprises a frame; a piston-cylinder supported on the frame, the piston-cylinder including a cylinder and a piston rod that is movable into an extended position from the cylinder to raise the load; and the supporting collar described above located on the piston rod and configured to support a weight of the load.

In embodiments the grip actuator includes a first grip lever on the first body portion and a second grip lever on the second body portion, and wherein pinching the first grip lever and the second grip lever together pivots the first sidewall segment and the second sidewall segment apart from each other. Optionally the pivot hinge includes a spring that biases the first body portion and the second body portion into the closed position. Optionally the first sidewall segment and the second sidewall segment are configured to be clamped onto the piston rod by the spring. Optionally the lift system further comprising a ramped entryway at an opening between the first body portion and the second body portion, the ramped entryway being configured to bias the first sidewall segment and the second sidewall segment apart from each other into the open position as the ramped entryway is radially slid onto the piston rod.

In embodiments the supporting collar is a first supporting collar and further comprising a second supporting collar as described above, the second supporting collar being stacked on top of the first supporting collar on the piston rod. Optionally the first supporting collar has a first thickness dimension and the second supporting collar has a second thickness dimension that is different than the first thickness dimension. Optionally the first supporting collar and the second supporting collar each includes a sidewall configured to support the weight of the load.

Various other features, objects and advantages of the present disclosure will be made apparent from the following description taken together with the drawings.

### BRIEF DESCRIPTION OF THE DRAWINGS

Embodiments are described with reference to the following drawing figures. The same numbers are used throughout to reference like features and components.

FIG. 1 is a perspective view of an embodiment of a lift system having a supporting collar assembly.

FIG. 2 is a side elevation view of the lift system of FIG. 1 supporting a load with the supporting collar assembly.

FIG. 3 is a detailed perspective view of the lift system of FIG. 2 with a first supporting collar on a piston rod of the lift system.

FIG. 4 is a view of section 4-4, taken in FIG. 3.

FIG. 5 is a perspective view of the first supporting collar of FIG. 4.

FIG. 6 is an exploded perspective view of the first supporting collar of FIG. 5.

FIG. 7 is a partial section view of the first supporting collar of FIG. 5 in an open position (solid lines) and a closed position (dashed lines).

### DETAILED DESCRIPTION OF THE DRAWINGS

As used herein, unless otherwise limited or defined, discussion of particular directions is provided by example only, with regard to particular embodiments or relevant illustrations. For example, discussion of “top,” “bottom,” “front,” “rear,” “left,” “right,” “horizontal,” “vertical,” and “longitudinal” features and/or relative motion, e.g., movement “up” and “down,” is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally or alternatively, embodiments may be arranged in a different orientation such that “top” and “bottom” features are arranged horizontally relative to each other, for example in a “left-to-right” orientation. Additionally, use of the words “first,” “second”, “third,” etc. is not intended to connote priority, importance, etc., but merely to distinguish one of several similar elements from another.

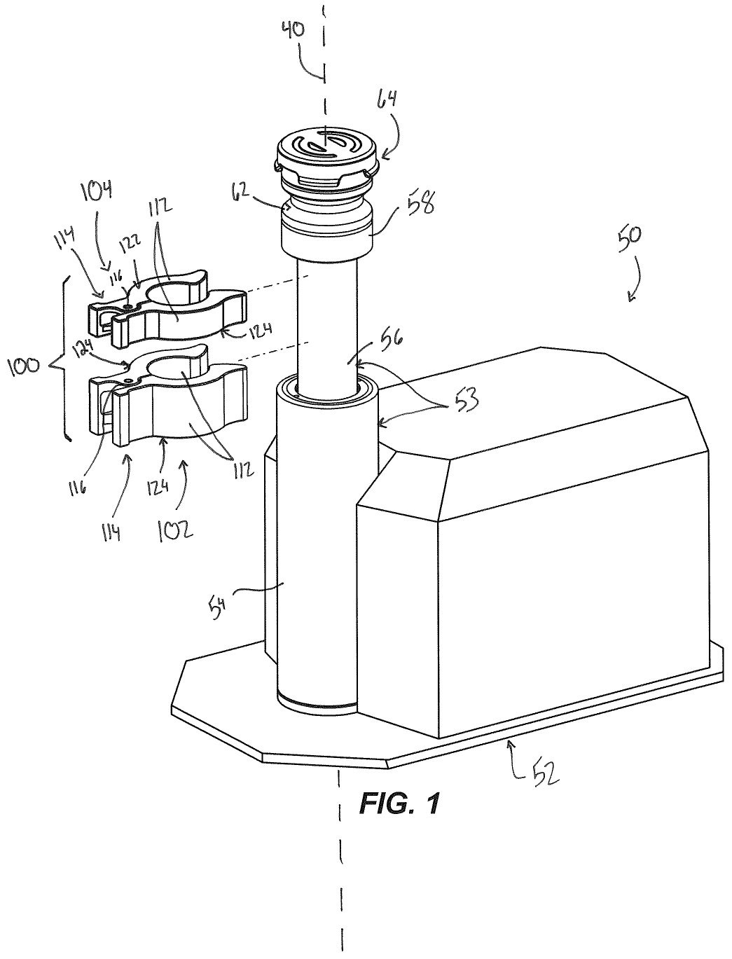

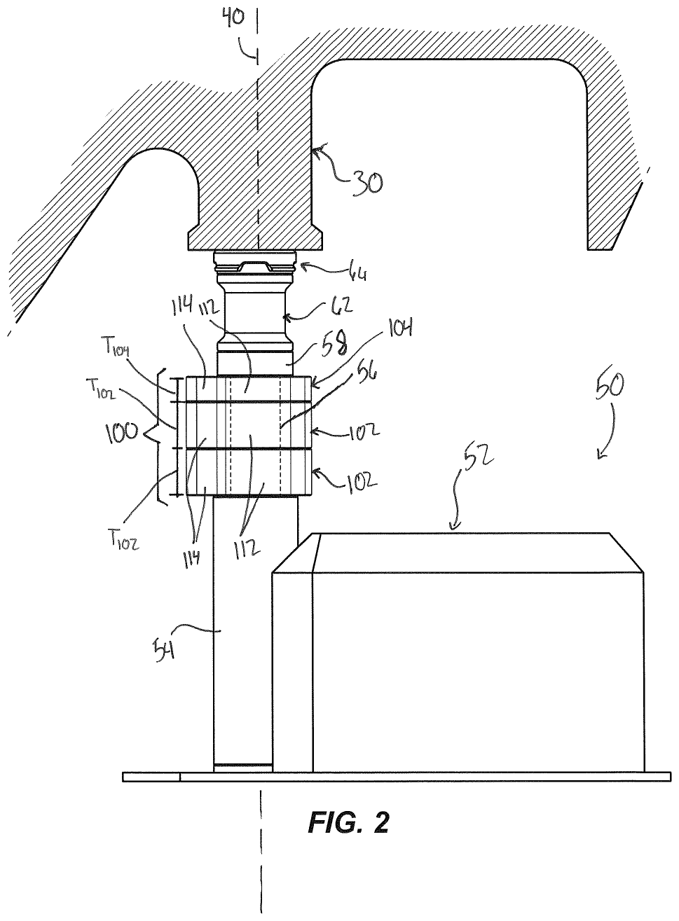

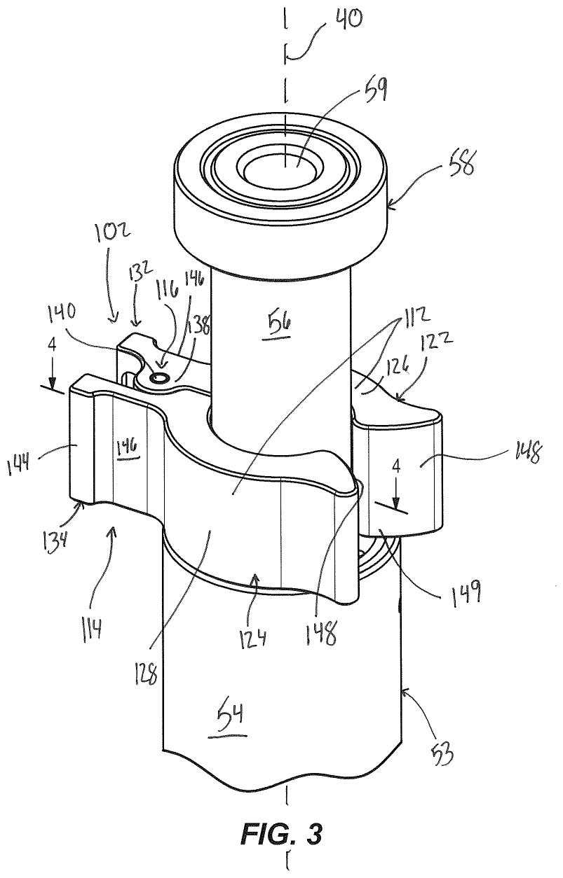

FIGS. 1 and 2 illustrate an embodiment of a lift system 50 including a frame 52, a piston-cylinder assembly 53 that is supported on the frame 52, and a supporting collar assembly 100 including a plurality of novel supporting collars 102, 104 configured to be received on the piston-cylinder assembly 53 to support a load 30 (FIG. 2) on the piston-cylinder assembly 53. The piston-cylinder assembly 53 includes a piston cylinder 54 and a piston rod 56 that movable within the piston cylinder 54 along an axis of extension 40 (FIG. 1) from a lowered position to an extended position (FIG. 2) in order to lift the load 30. A load support flange 58 at a distal end of the piston rod 56 may be configured to support the load thereon. Some embodiments, however, may be configured with at least one load supporting device for supporting the load 30 on the piston rod 56. For example, as illustrated in FIGS. 1 and 2, a rod extension 62 and/or a load cap 64 may be stacked on the piston rod 56, for example to increase the length of the piston rod 56 and/or to provide a suitable surface for supporting a load on the piston-cylinder assembly 53. In some embodiments, a portion of the rod extension 62 and/or load cap 64 may be received in an opening 59 (FIG. 3) formed axially into the piston rod 56 in order to retain the rod extension 62 and/or load cap 64 on the distal end of the piston rod 56. Embodiments of a lift system 50 may be equipped with hydraulic systems, pneumatic systems, mechanical systems, and/or any other conventional system components for actuating the piston rod 56 to extend from the piston cylinder 5.

As previously mentioned, some embodiments of a lift system 50 may be configured with a supporting collar assembly 100 including multiple supporting collars 102, 104 configured to be installed on the piston rod 56 in order to support the piston rod 56 in the extended position. Referring to FIGS. 1-3, the illustrated supporting collar assembly 100 includes multiple differently sized supporting collars 102, 104 that may be installed on the piston rod 56 individually (FIG. 3) and/or in a stacked configuration (FIG. 2). This may be useful, for example, in order to support the piston rod 56 at various different extension lengths. In FIG. 2, the supporting collar assembly 100 includes two first supporting collars 102 that each have a first thickness dimension T102 and one second supporting collar 104 that has a second thickness dimension T104 that is less than the first thickness dimension T102. Thus, the illustrated second supporting collar 104 is thinner than the first supporting collars 102. Some embodiments, however, may include a different number of first supporting collars 102 and/or second supporting collars. Additionally or alternatively, embodiments of a supporting collar assembly may include at least one supporting collar with a thickness dimension that is different than those of the illustrated embodiments.

In the illustrated embodiments, the first supporting collars 102 and the second supporting collars 104 are generally the same except for the difference in their thickness dimensions T102, T104. Thus, features discussed in reference to one type of supporting collar 102, 104 are also applicable to the other type(s) of supporting collars. Some embodiments, however, may include at least one different type of supporting collar.

Referring to FIGS. 3-6, each of the first supporting collars 102 (as well as the second supporting collars 104) includes a first body portion 122 and a second body portion 124 that is pivotably coupled to the first body portion 122 at a pivot hinge 116. The first body portion 122 and the second body portion 124 collectively form a sidewall 112 extending in a first direction from the pivot hinge 116 and a grip actuator 114 extending from the pivot hinge 116 in a second direction opposite the first direction. The sidewall 112 is generally semicircular and defines a gap 130 between the first body portion 122 and the second portion 124 into which the piston rod 56 may be received. When at least one supporting collar 102, 104 is installed on the piston rod (FIGS. 2-4), the sidewalls 112 of said supporting collar(s) 102, 104 are configured to support the weight of a load 30 on the piston rod 56. The grip actuator 114 also advantageously provides a grip by which a user may hold the supporting collar 102 and may be used as an actuator to pivot the first and second body portions 122, 124 into and between the open position and the closed position, as discussed in further detail below.

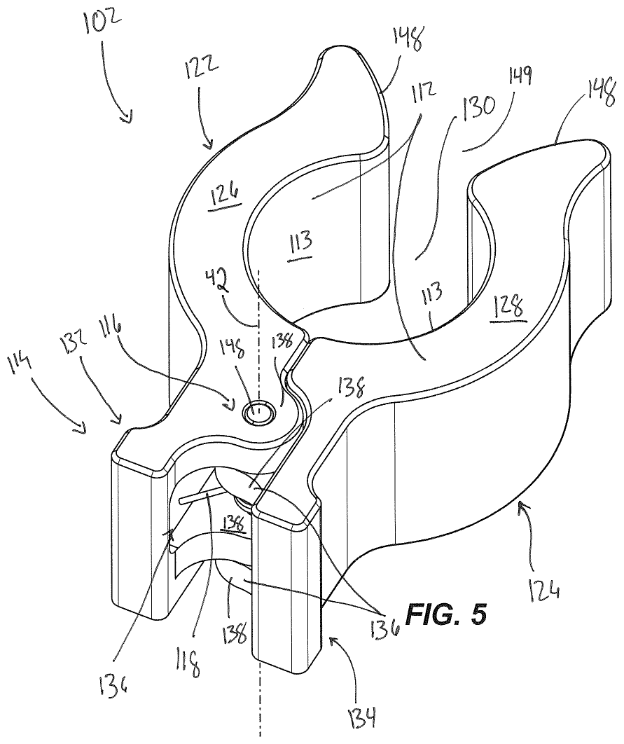

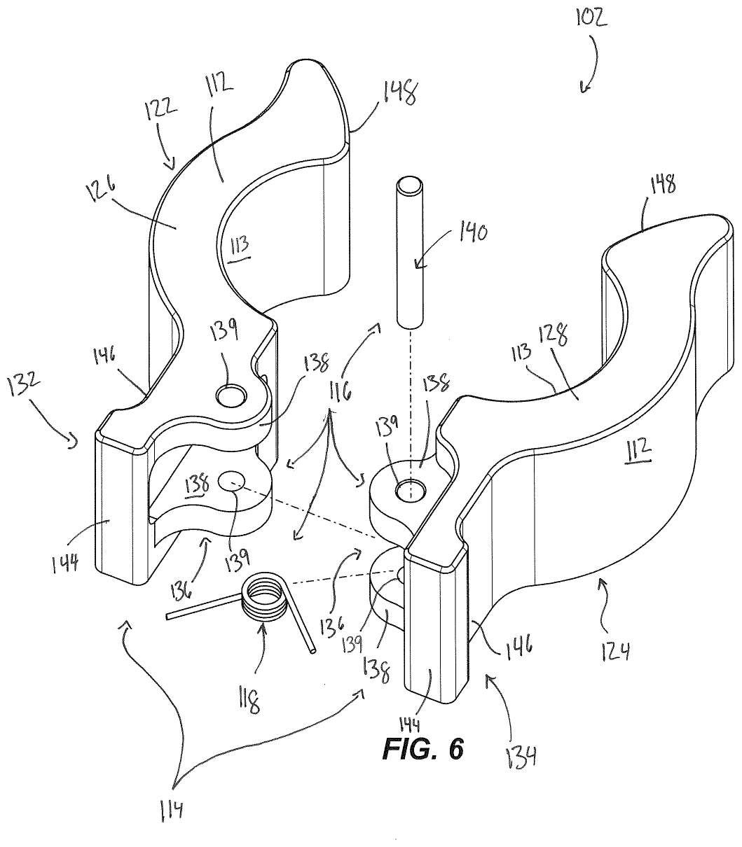

Referring to FIGS. 5 and 6, the sidewall 112, the grip actuator 114, and the pivot hinge 116 are provided by the first body portion 122 and the second body portion 124. The pivot hinge 116 includes a pivot bracket 136 on the first body portion 122 and the second body portion 124 and a pivot shaft 140 that pivotably couple the two pivot brackets 136 together such that the first and second body portions 122, 124 are pivotable relative to each other about a pivot axis 42 (FIG. 5). Each pivot bracket 136 includes two spaced apart bracket plates 138 with an opening 139 configured to receive the pivot shaft 140. The spacing between the bracket plates 138 allows the pivot bracket 136 on the first body portion 122 to be interdigitated with the pivot bracket 136 on the second body portion 124 such that the pivot shaft may extend through both pivot brackets 136 to couple the first and second body portions 122, 124. The pivot hinge 116 additionally includes a spring 118 received on the pivot shaft 140 and configured to bias the first and second body portions 122, 124 into the closed position, as discussed in further detail below.

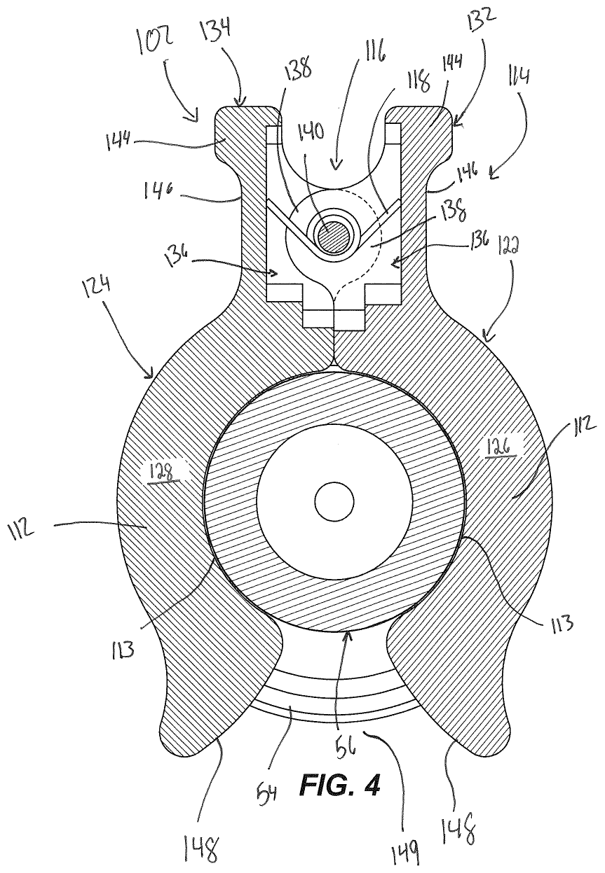

With continued reference to FIGS. 5 and 6, the sidewall 112 includes a first sidewall segment 126 extending from the pivot bracket 136 on the first body portion 122 and a second sidewall segment 128 extending from the pivot bracket 136 on the second body portion 124. The first sidewall segment 126 and the second sidewall segment 128 are generally C-shaped and have a radially inner surface 113 configured to at least partially conform to the radially outer surface of the piston rod 56 when the piston rod 56 is received in the gap 130 between the first and second sidewall segments 126, 128 (FIG. 4). Each sidewall segment 126, 128 extends from the corresponding pivot bracket 136 to a ramped abutment surface 148 at a distal end of said sidewall segment 126, 128. The ramped abutment surfaces 148 on the first and second body portions 122, 124 are spaced apart from each other and define a ramped entryway 149 into the gap 130. The opposing ramped abutment surfaces 148 are sloped such that pressing the ramped entryway 149 towards the piston rod 56 creates a reaction force that biases the first and second body portions 122, 124 towards the open position so that the supporting collar 102 can be slid onto the piston rod 56, which engages the opposing ramped abutment surfaces 148 with the outer diameter of the piston rod 56 and forces the first and second body portions 122, 124 towards the open position against the bas of the spring 118. Once the opposing ramped abutment surfaces 148 are slid over the outer diameter, the spring 118 biases the first and second body portions 122, 124 back into the closed position. Conversely, pulling the supporting collar 102 (or the supporting collar 104) radially off of the piston rod 56 causes the piston rod 56 to engage with the inner surface 113 of the first and second body portions 122, 124 and forces the opposing ramped abutment surfaces 148 apart from each other thus facilitating sliding of the supporting collar 102 off of the piston rod 56.

As previously mentioned, the first and second body portions 122, 124 each also include part of the grip actuator 114 for moving the first and second body portions 122, 124 into and between the open position and the closed position. Referring to FIGS. 5 and 6, the grip actuator 114 includes a first grip lever 132 on the first body portion 122 and an opposing second grip lever 134 on the second body portion 124. The first and second grip levers 132, 134 each extend away from the pivot bracket 136 on the corresponding first or second body portion 122, 124 in a direction opposite the first and second sidewall segments 126, 128. Each grip lever 132, 134 includes a protrusion 144 at the distal end of said grip lever 132, 134 and a grip groove 146 defined between the protrusion 144 and the first or second sidewall segment 126, 128. Advantageously, grip grooves 146 allow a user to easily hold the supporting collar 102.

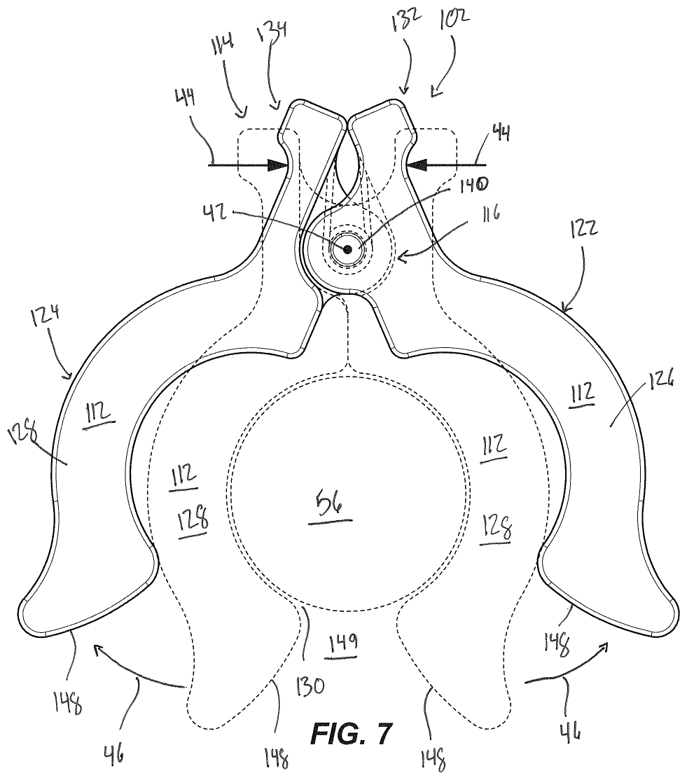

Referring to FIG. 7, embodiments of a supporting collar 102, 104 can be moved into and between the open position (shown in solid lines) and the closed position (shown in dashed lines) using the grip actuator 114, thereby facilitating installment and removal of the respective supporting collar 102, 104 on and off of the piston rod 56. To move the first body portion 122 and the second body portion 124 into the open position, a user holding a supporting collar 102 by the grip actuator 114 pinches the opposing grip levers 132, 134 together (e.g., in the direction of arrows 44 in FIG. 7), thereby causing the first and second body portions to pivot about the pivot axis 42 defined by the pivot shaft 140. As the first and second grip levers 132, 134 are pinched, the spring 118 of the pivot hinge 116 resists the compression of the grip levers 132, 134. Pivoting motion of the first and second body portions 122, 124 causes the first sidewall segment 126 and the second sidewall segment 128 to pivot apart from each other (e.g., in the direction of arrows 46 in FIG. 7), thereby widening the ramped entryway 149 and the gap 130 between the sidewall segments 126, 128 and placing the first and second body portions in the open position. When in the open position, the supporting collar 102 can more easily slide on to or off of the piston rod 56.

To return the first body portion 122 and the second body portion 124 to the closed position, a user may release the pinching pressure from the grip levers 132, 134, thereby allowing the spring 118 to bias the first sidewall segment 126 and the second sidewall segment 128 back towards each other (e.g., in an opposite direction than the arrows 46 in FIG. 7), thereby closing the ramped entryway 149. When in the closed position, the sidewall segments 126, 128 conform the piston rod 56 to retain the piston rod 56 in the gap 130 between the opposing sidewall segments 126, 128, thereby retaining the supporting collar 102 on the piston rod.

Referring to FIGS. 2 and 3, to support the weight of a load on the piston rod 56 of the lift system 50, at least one supporting collar 102, 104 of the supporting collar assembly 100 may be installed on the piston rod 56 above the piston cylinder 54 and below the load support flange 58 on the top of the piston rod 56 after the piston rod 56 has been extended to raise a load 30 (FIG. 2) the desired height. To install the supporting collars 102, 104, a user may control the lift system 50 to extend the piston rod 56 an insertion length in which the load 30 is lifted is higher than the desired final height of the load 30 (FIG. 2). Once the piston rod 56 is extended to the insertion length, the supporting collars 102, 104 may be sequentially installed on the piston rod 56 by sliding the supporting collars 102, 104 onto the piston rod 56 such that the piston rod 56 is received in the gaps 130 defined by the sidewalls 112 and the supporting collars 102, 104 are generally coincident with the axis of extension 40 defined by the piston-cylinder assembly 53.

After the requisite number of supporting collars 102, 104 has been installed (i.e., the required number of supporting collars 102, 104 to support the load 30 at its desired height), the piston rod 56 may be retracted into the piston cylinder 54. As the piston rod 56 is retracted, the weight of the load 30 is shifted from the piston rod 56 to the supporting collars 102, 104. When the load 30 is at the desired height, the axial force from the weight of the load 30 is transmitted to the piston cylinder 54 via the load support flange 58 and the supporting collar assembly 100. Advantageously, the supporting collars 102, 104 relieve the force(s) applied to the piston rod 56 by the weight of the load 30, which may prevent damage to the piston-cylinder assembly 53.

In the present description, certain terms have been used for brevity, clarity, and understanding. No unnecessary limitations are to be implied therefrom beyond the requirement of the prior art because such terms are used for descriptive purposes only and are intended to be broadly construed. The different apparatuses described herein may be used alone or in combination with other apparatuses. Various equivalents, alternatives and modifications are possible within the scope of the appended claims.

What is claimed is:

1. A supporting collar for a lift system having a piston rod that is extendable out of a cylinder to raise a load, the supporting collar comprising:
a first body portion including a first sidewall segment;
a second body portion pivotably coupled to the first body portion by a pivot hinge, the second body portion comprising a second sidewall segment;
wherein the first body portion and the second body portion are pivotable relative to each other into an open position in which the piston rod is receivable between the first sidewall segment and the second sidewall segment and a closed position in which the piston rod is retained between the first sidewall segment and the second sidewall segment;
wherein the first sidewall segment and the second sidewall segment are configured to support a weight of the load; and
a grip actuator configured for a user to pivot the first body portion and the second body portion into the open position.

2. The supporting collar according to claim 1, wherein the grip actuator includes a first grip lever on the first body portion and a second grip lever on the second body portion, and wherein pinching the first grip lever and the second grip lever together pivots the first sidewall segment and the second sidewall segment apart from each other.

3. The supporting collar according to claim 1, wherein the pivot hinge includes a spring that biases the first body portion and the second body portion into the closed position.

4. The supporting collar according to claim 3, wherein the first sidewall segment and the second sidewall segment are configured to be clamped onto the piston rod by the spring.

5. The supporting collar according to claim 1, further comprising a ramped entryway at an opening between the first body portion and the second body portion, the ramped entryway being configured to bias the first sidewall segment and the second sidewall segment apart from each other into the open position as the ramped entryway is radially slid onto the piston rod.

6. The supporting collar according to claim 2, wherein the pivot hinge includes a spring that biases the first body portion and the second body portion into the closed position.

7. The supporting collar according to claim 6, wherein the first sidewall segment and the second sidewall segment are configured to be clamped onto the piston rod by the spring.

8. The supporting collar according to claim 7, further comprising a ramped entryway at an opening between the first body portion and the second body portion, the ramped entryway being configured to bias the first sidewall segment and the second sidewall segment apart from each other into the open position as the ramped entryway is radially slid onto the piston rod.

9. A lift system for lifting a load, the lift system comprising:
a frame;
a piston-cylinder supported on the frame, the piston-cylinder including a cylinder and a piston rod that is movable into an extended position from the cylinder to raise the load; and
the supporting collar according to claim 1 located on the piston rod and configured to support a weight of the load.

10. The lift system according to claim 9, wherein the grip actuator includes a first grip lever on the first body portion and a second grip lever on the second body portion, and wherein pinching the first grip lever and the second grip lever together pivots the first sidewall segment and the second sidewall segment apart from each other.

11. The lift system according to claim 10, wherein the pivot hinge includes a spring that biases the first body portion and the second body portion into the closed position.

12. The lift system according to claim 11, wherein the first sidewall segment and the second sidewall segment are configured to be clamped onto the piston rod by the spring.

13. The lift system according to claim 12, further comprising a ramped entryway at an opening between the first body portion and the second body portion, the ramped entryway being configured to bias the first sidewall segment and the second sidewall segment apart from each other into the open position as the ramped entryway is radially slid onto the piston rod.

14. The lift system according to claim 9, wherein the supporting collar is a first supporting collar and further comprising a second supporting collar according to claim 9, the second supporting collar being stacked on top of the first supporting collar on the piston rod.

15. The lift system according to claim 14, wherein the first supporting collar has a first thickness dimension and the second supporting collar has a second thickness dimension that is different than the first thickness dimension.

16. The lift system according to claim 15, wherein the first supporting collar and the second supporting collar each includes a sidewall configured to support the weight of the load.
